(19) United States
(12) Patent Application Publication
(10) Pub. No.: US 2025/0251603 A1
(43) Pub. Date: Aug. 7, 2025

(54) SMART GLASSES AND SMART GLASSES ASSEMBLY

(71) Applicants: Fu Tai Hua Industry (Shenzhen) Co., Ltd., Shenzhen (CN); HON HAI PRECISION INDUSTRY CO., LTD., New Taipei (TW)

(72) Inventor: Xian Lu, Shenzhen (CN)

(21) Appl. No.: 19/014,488

(22) Filed: Jan. 9, 2025

(30) Foreign Application Priority Data
Feb. 1, 2024 (CN) 202410157955.1

(51) Int. Cl. G02B 27/01

(52) U.S. Cl. CPC G02B 27/0172; G02B 2027/0118; G02B 2027/0178

(57) ABSTRACT

A pair of smart glasses includes a frame, a lens, and a shading mechanism. The lens is disposed in the frame. The shading mechanism includes a first housing and a shading element. The first housing is detachably connected to the frame. The first housing includes a containing cavity, and the shading element is accommodated in the containing cavity and is configured to extend out from the containing cavity to cover the lens. The present disclosure further includes a smart glasses assembly including the smart glasses.

### FIELD

The subject matter herein generally relates to augmented reality, and more particularly, to smart glasses and smart glasses assembly.

### BACKGROUND

When a user watches a movie using Augmented Reality glasses (AR glasses), if a brightness of the external environment exceeds a brightness of the display screen of the AR glasses, images displayed on the AR glasses will appear dark, and the user may easily see the external objects directly through the AR glasses, affecting a viewing experience. Therefore, there is room for improvement in the art.

### BRIEF DESCRIPTION OF THE DRAWINGS

Implementations of the present technology will now be described, by way of example only, with reference to the attached figures.

FIG. 1 is a diagrammatic view of a pair of smart glasses according to an embodiment of the present disclosure.

FIG. 2 is a diagrammatic view showing a shading element of the pair of smart glasses being pulled out according to an embodiment of the present disclosure.

FIG. 3 is a top view of a first housing of the pair of smart glasses of FIG. 1.

FIG. 4 is a diagrammatic view of a first connecting member and a second connecting member of the pair of smart glasses of FIG. 1.

FIG. 5 is a diagrammatic view of a base of the pair of smart glasses of FIG. 1.

FIG. 6 is a side view of the first housing of the pair of smart glasses of FIG. 1.

FIG. 7 is a diagrammatic view of a second housing of the pair of smart glasses of FIG. 1.

FIG. 8 is a block diagram of a smart glasses assembly according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

Some embodiments of the present disclosure will be described in detail with reference to the drawings. If no conflict, the following embodiments and features in the embodiments can be combined with each other.

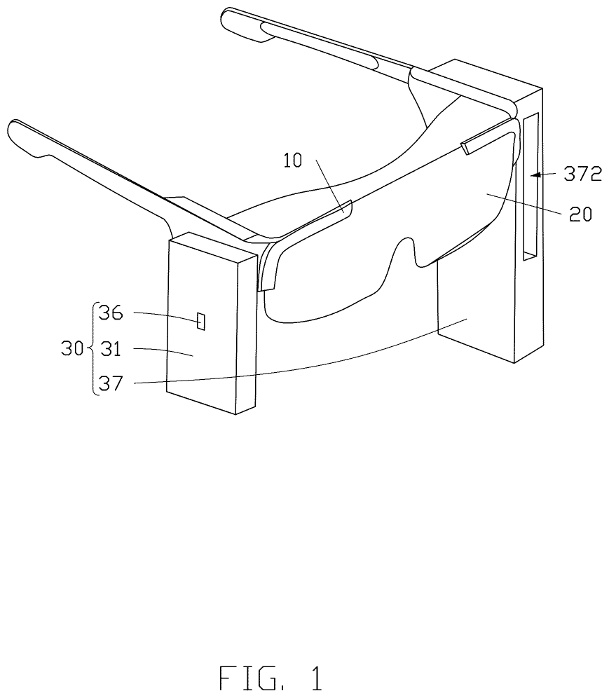

Referring to FIGS. 1, 2, and 3, a pair of smart glasses 100 is provided according to an embodiment of the present disclosure. The smart glasses 100 include a frame 10, a lens 20, and a shading mechanism 30. The lens 20 is installed in the frame 10. The shading mechanism 30 includes a first housing 31 and a shading element 32. The first housing 31 is detachably connected to the frame 10. The first housing 31 includes a containing cavity 311. The shading element 32 is accommodated in the containing cavity 311, and can extend out from the containing cavity 311 to cover the lens 20.

When a user senses strong brightness of an external light source, the shading element 32 can be pull out from the first housing 31 and to cover a side of the lens 20 facing the external light source. Thus, the shading element 32 can block a portion of the light emitted by the external light source and improve the user's viewing experience.

In the embodiment, the first housing 31 is connected to a left side or a right side of the frame 10. When the smart glasses 100 are in use, the shading element 32 can be pulled out from the containing cavity 311 of the first housing 31 from left to right or from right to left. In other embodiments, the first housing 31 may also be connected to a top of the frame 10, allowing the user to pull out the shading element 32 from the containing cavity 311 of the first housing 31 from top to bottom when in use, improving the convenience when pulling the shading element 32.

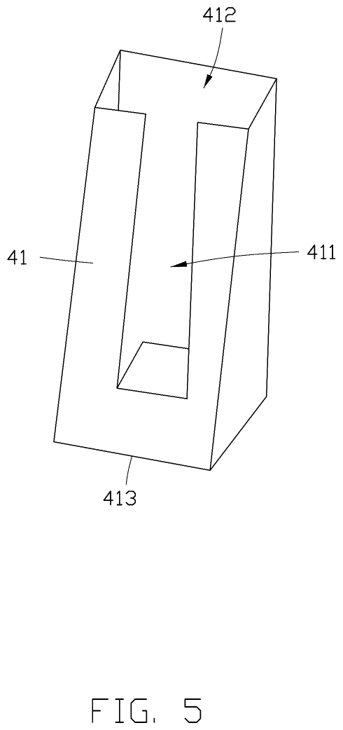

Referring to FIGS. 1, 4, and 5, in some embodiments, the smart glasses 100 further include a first connecting member 40. The first connecting member 40 includes a base 41 and a sliding block 42. The base 41 is connected to the frame 10, and a sliding groove 411 is defined at a side of the base 41 facing away from the frame 10. The sliding block 42 is connected to a side of the first housing 31 facing the frame 10, and the sliding block 42 is slidably disposed in the sliding groove 411, such that the first housing 31 can be detachably connected to the frame 10.

The base 41 further includes an opening 412 communicating with the sliding groove 411. The opening 412 can allow the sliding block 42 connected to the first housing 31 to slide into the sliding groove 411 through the opening 412, or to slide out of the sliding groove 411 through the opening 412, thereby enhancing the convenience of detaching or attaching the shading mechanism 30 from the frame 10.

An end of the base 41 opposite to the opening 412 includes a supporting portion 413. The supporting portion 413 can resist against the sliding block 42 sliding into the sliding groove 411, thereby preventing the sliding block 42 from disengaging from the base 41 due to gravity of the sliding block 42.

In other embodiments, the first connecting member 40 may also be a buckle or magnetic attraction structure.

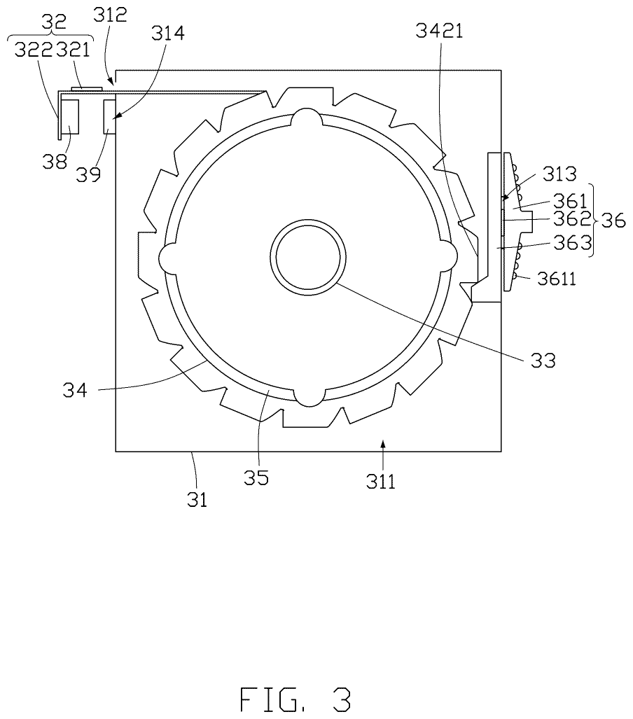

Referring to FIGS. 3, 4, and 6, in some embodiments, the shading mechanism 30 (shown in FIG. 1) further includes a shaft 33, a rotating member 34, and an elastic member 35. The shaft 33 is disposed in the containing cavity 311, and the rotating member 34 is sleeved on the shaft 33. The elastic member 35 is wound around the shaft 33, and two ends of the elastic member 35 are connected to the shaft 33 and the rotating member 34. The elastic member 35 can drive the rotating member 34 to rotate relative to the shaft 33. The first housing 31 further includes a hole 312 connected to the containing cavity 311. One end of the shading element 32 is connected to and wrapped around the rotating member 34, and another end of the shading element 32 can extend through the hole 312 to cover the lens 20. In other embodiments, the elastic member 35 may also be a spiral spring.

Referring to FIGS. 3, 4, and 6, in some embodiments, the shading mechanism 30 further includes a limiting member 36. The limiting member 36 includes a pushing portion 361, a connecting portion 362, and a stopping portion 363. The first housing 31 further includes a through hole 313 communicating with the containing cavity 311. The pushing portion 361 is slidably connected to the first housing 31. One end of the connecting portion 362 is connected to the pushing portion 361, and another end of the connecting portion 362 extends through the through hole 313 into the containing cavity 311. The stopping portion 363 is connected to a side of the connecting portion 362 facing away from the pushing portion 361. The pushing portion 361 can push the stopping portion 363 to resist against the rotating member 34. Since the pushing portion 361 is used to control the stopping portion 363 to resist against the rotating member 34, the rotating member 34 can be fixed by the stopping portion 363, thus improving a stability of the shading element 32 when the shading element 32 is pull out from the first housing 31 to be an unfolded state.

In some embodiments, a friction layer 3611 is provided on the pushing portion 361. The friction layer 3611 can increase a friction coefficient when the user pushes the pushing portion 361 to move relative to the first housing 31.

In the embodiment, the first housing 31 has a rectangular structure. In other embodiments, the first housing 31 may also have a circular structure or other polygonal structures.

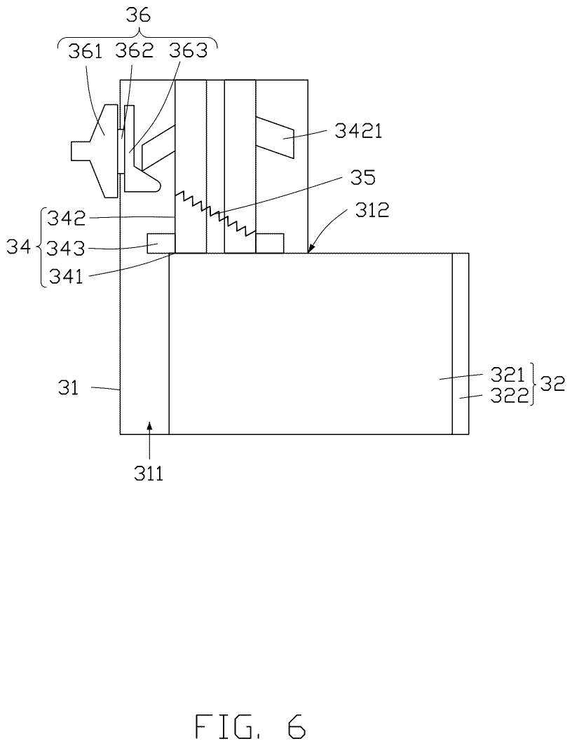

Referring to FIGS. 3 and 6, in some embodiments, the rotating member 34 includes a first rotating portion 341 and a second rotating portion 342 connected to each other in an axial direction of the shaft 33. The elastic member 35 is disposed in the first rotating portion 341. The shading element 32 is wound around the first rotating portion 341, and an outer sidewall of the second rotating portion 342 includes a plurality of ratchet teeth 3421 evenly spaced along the circumferential direction of the second rotating portion 342. The ratchet teeth 3421 can be resisted against the stopping portion 363. The stopping portion 363 can be resisted against any one of the ratchet teeth 3421, thereby ensuring the position accuracy of the rotating member 34, and reducing a risk of the shading element 32 returning back into the first housing 31 during use.

Referring to FIGS. 3 and 6, in some embodiments, the rotating member 34 further includes a limiting portion 343 disposed between the first rotating portion 341 and the second rotating portion 342. The limiting portion 343 protrudes from the first rotating portion 341 and the second rotating portion 342. The limiting portion 343 can cooperate with a cavity wall of the containing cavity 311 to limit the shading element 32 in the axial direction of the shaft 33, thereby reducing a risk of the shading element 32 deviated from the desired position when the shading element 32 is wound or pulled out.

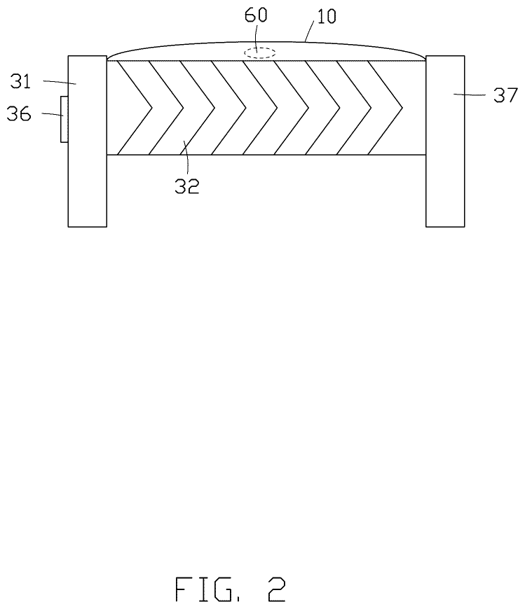

Referring to FIGS. 1 and 2, in some embodiments, the shading mechanism 30 further includes a second housing 37 detachably connected to a side of the frame 10 opposite to the first housing 31. The second housing 37 can fix a portion of the shading element 32 extending out of the first housing 31. In the embodiment, the second housing 37 has a rectangular structure. In other embodiments, the second housing 37 may also have a circular structure or other polygonal structures.

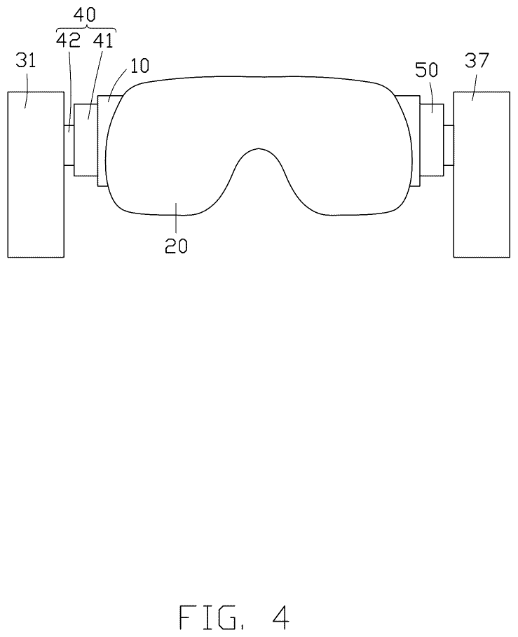

Referring to FIGS. 1 and 4, in some embodiments, the smart glasses 100 further include a second connecting member 50, which has the same structure as the first connecting member 40. Thus, the second housing 37 can be detachably connected to the frame 10. In other embodiments, the second connecting member 50 may also be a buckle or a magnetic suction structure.

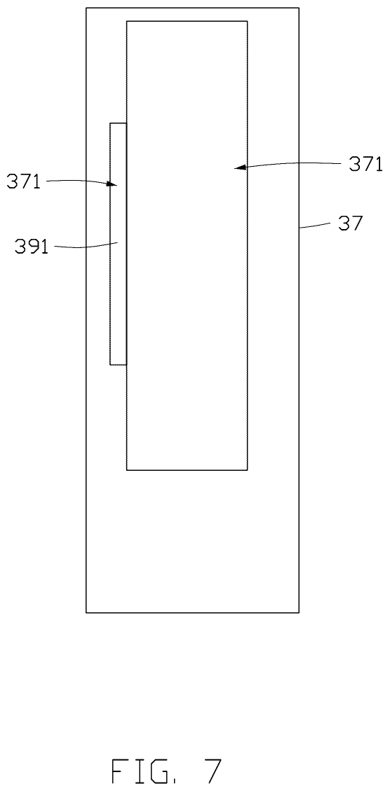

Referring to FIGS. 3, 6, and 7, in some embodiments, the shading element 32 includes a shading band 321 and a latch hook 322. The shading band 321 is connected to the first rotating portion 341, and the latch hook 322 is connected to a side of the shading band 321 facing away from the first rotating portion 341. The latch hook 322 can be exposed from the hole 312 when the shading band 321 is wound. The second housing 37 includes a slot 371, and the latch hook 322 can further extend into the slot 371 to connect to the second housing 37 when the shading band 321 covers the lens 20. The latch hook 322 and the slot 371 are engaged with each other to fix the shading band 321, thereby enhancing the stability of the shading band 321 when the shading band 321 is in the unfolded state.

In the embodiment, when the shading band 321 is in the unfolded state, the shading band 321 forms an arcuate structure, and a gap is formed between the shading band 321 and the lens 20. The gap between the shading band 321 and the lens 20 can improve the viewing experience compared to the shading band 321 directly covering the lens 20.

In other embodiments, a positioning pin (not shown) can be used to replace the latch hook 322. A positioning hole is defined on the second housing 37. When the shading band 321 extends from the first housing 31 and in the unfolded state, the user can insert the positioning pin into the positioning hole to fix the shading band 321.

Referring to FIGS. 3, 6, and 7, in some embodiments, the shading mechanism 30 further includes a first magnetic member 38 and a second magnetic member 39. The first magnetic member 38 is connected to the latch hook 322. A sidewall of the first housing 31 near the hole 312 includes a first groove 314, and the second magnetic member 39 is disposed in the first groove 314. The second magnetic member 39 can attract the first magnetic member 38 when the shading band 321 is wound. When the shading band 321 is in the wound state, the first magnetic member 38 and the second magnetic member 39 attract each other, thereby enhancing the stability of the shading band 321 when the shading band 321 is disposed in the containing cavity 311. In other embodiments, the first magnetic member 38 and the second magnetic member 39 may also be magnet with opposite magnetic polarities.

Referring to FIGS. 3, 6, and 7, in some embodiments, the shading mechanism 30 (shown in FIG. 1) further includes a third magnetic member 391. The second housing 37 further includes a second groove 372 communicating with the slot 371, and the third magnetic member 391 is disposed in the second groove 372. The third magnetic member 391 can attract the first magnetic member 38 when the shading band 321 covers the lens 20. When the shading band 321 is in the unfolded state, the first magnetic member 38 and the third magnetic member 391 attract each other, thereby enhancing the stability of the latch hook 322 when the latch hook 322 is disposed in the slot 371. In other embodiments, the first magnetic member 38 and the third magnetic member 391 are magnets with opposite magnetic polarities.

Referring to FIGS. 1 and 2, in some embodiments, the smart glasses 100 further include a light sensor 60 connected to the frame 10 and disposed adjacent to the lens 20. The light sensor 60 can detect the brightness of external light sources. When the detected brightness of the external light source exceeds a preset light threshold, the light sensor 60 prompts the user to unfold the shading element 32. For example, the light sensor 60 can generate a prompt to alert the user to pull out the shading element 32 from the first housing 31, thereby enhancing the viewing experience.

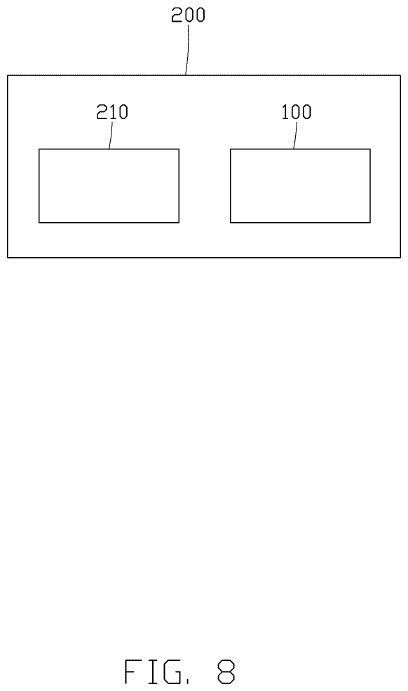

Referring to FIG. 8, a smart glasses assembly 200 is provided according to an embodiment of the present disclosure. The smart glasses assembly 200 includes the smart glasses 100 and a glasses case 210. The glasses case 210 can accommodate the smart glasses 100.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A pair of smart glasses comprising:
a frame;
a lens disposed in the frame; and
a shading mechanism comprising a first housing and a shading element;
wherein the first housing is detachably connected to the frame, the first housing comprises a containing cavity, and the shading element is accommodated in the containing cavity and configured to extend out from the containing cavity to cover the lens.

2. The pair of smart glasses of claim 1, wherein the shading mechanism further comprises a shaft, a rotating member, and an elastic member, the shaft is disposed in the containing cavity, the rotating member is sleeved on the shaft, the elastic member is wound around the shaft, two ends of the elastic member are connected to the shaft and the rotating member respectively, the elastic member is configured to drive the rotating member to rotate relative to the shaft;
the first housing further comprises a hole connected to the containing cavity, one end of the shading element is connected to and wrapped around the rotating member, and another end of the shading element is configured to extend through the hole to cover the lens.

3. The pair of smart glasses of claim 2, wherein the shading mechanism further comprises a limiting member, the limiting member comprises a pushing portion, a connecting portion, and a stopping portion, the first housing further comprises a through hole communicating with the containing cavity, the pushing portion is slidably connected to the first housing, one end of the connecting portion is connected to the pushing portion, another end of the connecting portion extends through the through hole into the containing cavity, the stopping portion is connected to a side of the connecting portion away from the pushing portion, and the pushing portion is configured to push the stopping portion to resist against the rotating member.

4. The pair of smart glasses of claim 3, wherein the rotating member comprises a first rotating portion and a second rotating portion connected to each other in an axial direction of the shaft, the elastic member is disposed in the first rotating portion, the shading element is wound around the first rotating portion, the second rotating portion comprises a plurality of ratchet teeth evenly spaced from each other along an circumferential direction of the second rotating portion, and the plurality of ratchet teeth are configured to resist against the stopping portion.

5. The pair of smart glasses of claim 4, wherein the rotating member further comprises a limiting portion connected between the first rotating portion and the second rotating portion, and the limiting portion is configured to cooperate with the containing cavity to limit the shading element.

6. The pair of smart glasses of claim 4, wherein the shading mechanism further comprises a second housing detachably connected to a side of the frame opposite to the first housing, and the second housing is configured to fix a portion of the shading element extending out of the first housing.

7. The pair of smart glasses of claim 6, wherein the shading element comprises a shading band and a latch hook, the shading band is connected to the first rotating portion, the latch hook is connected to a side of the shading band away from the first rotating portion, the latch hook is exposed from the hole, the second housing comprises a slot, and the latch hook is further configured to extend into the slot to connect to the second housing when the shading band covers the lens.

8. The pair of smart glasses of claim 7, wherein the shading mechanism further comprises a first magnetic member and a second magnetic member, the first magnetic member is connected to the latch hook, the first housing comprises a first groove, the second magnetic member is disposed in the first groove, and the second magnetic member is configured to attract the first magnetic member when the shading band is wound.

9. The pair of smart glasses of claim 8, wherein the shading mechanism further comprises a third magnetic member, the second housing further comprises a second groove communicating with the slot, the third magnetic member is disposed in the second groove, and the third magnetic member is configured to attract the first magnetic member when the shading band covers the lens.

10. The pair of smart glasses of claim 1, further comprising a light sensor, wherein the light sensor is connected to the frame and disposed adjacent to the lens, and the light sensor is configured to detect a brightness of external light sources and to generate a prompt when the detected brightness is greater than a preset light threshold.

11. The pair of smart glasses of claim 1, further comprising at least one connecting member, wherein the at least one connecting member comprises a base and a sliding block, the base is connected to the frame, a side of the base away from the frame defines a sliding groove, the sliding block is connected to a side of the first housing facing the frame, and the sliding block is slidably disposed in the sliding groove.

12. A smart glasses assembly comprising:
a glasses case; and
a pair of smart glasses, the glasses case configured to accommodate the smart glasses, the pair of smart glasses comprising:
a frame;
a lens disposed in the frame; and
a shading mechanism comprising a first housing and a shading element;
wherein the first housing is detachably connected to the frame, the first housing comprises a containing cavity, and the shading element is accommodated in the containing cavity and configured to extend out from the containing cavity to cover the lens.

13. The smart glasses assembly of claim 12, wherein the shading mechanism further comprises a shaft, a rotating member, and an elastic member, the shaft is disposed in the containing cavity, the rotating member is sleeved on the shaft, the elastic member is wound around the shaft, two ends of the elastic member are connected to the shaft and the rotating member respectively, the elastic member is configured to drive the rotating member to rotate relative to the shaft;
the first housing further comprises a hole connected to the containing cavity, one end of the shading element is connected to and wrapped around the rotating member, and another end of the shading element is configured to extend through the hole to cover the lens.

14. The smart glasses assembly of claim 13, wherein the shading mechanism further comprises a limiting member, the limiting member comprises a pushing portion, a connecting portion, and a stopping portion, the first housing further comprises a through hole communicating with the containing cavity, the pushing portion is slidably connected to the first housing, one end of the connecting portion is connected to the pushing portion, another end of the connecting portion extends through the through hole into the containing cavity, the stopping portion is connected to a side of the connecting portion away from the pushing portion, and the pushing portion is configured to push the stopping portion to resist against the rotating member.

15. The smart glasses assembly of claim 14, wherein the rotating member comprises a first rotating portion and a second rotating portion connected to each other in an axial direction of the shaft, the elastic member is disposed in the first rotating portion, the shading element is wound around the first rotating portion, the second rotating portion comprises a plurality of ratchet teeth evenly spaced from each other along an circumferential direction of the second rotating portion, and the plurality of ratchet teeth are configured to resist against the stopping portion.

16. The smart glasses assembly of claim 15, wherein the rotating member further comprises a limiting portion connected between the first rotating portion and the second rotating portion, and the limiting portion is configured to cooperate with the containing cavity to limit the shading element.

17. The smart glasses assembly of claim 15, wherein the shading mechanism further comprises a second housing detachably connected to a side of the frame opposite to the first housing, and the second housing is configured to fix a portion of the shading element extending out of the first housing.

18. The smart glasses assembly of claim 17, wherein the shading element comprises a shading band and a latch hook, the shading band is connected to the first rotating portion, the latch hook is connected to a side of the shading band away from the first rotating portion, the latch hook is exposed from the hole, the second housing comprises a slot, and the latch hook is further configured to extend into the slot to connect to the second housing when the shading band covers the lens.

19. The smart glasses assembly of claim 18, wherein the shading mechanism further comprises a first magnetic member and a second magnetic member, the first magnetic member is connected to the latch hook, the first housing comprises a first groove, the second magnetic member is disposed in the first groove, and the second magnetic member is configured to attract the first magnetic member when the shading band is wound.

20. The smart glasses assembly of claim 19, wherein the shading mechanism further comprises a third magnetic member, the second housing further comprises a second groove communicating with the slot, the third magnetic member is disposed in the second groove, and the third magnetic member is configured to attract the first magnetic member when the shading band covers the lens.
